(19) United States
(12) Patent Application Publication
(10) Pub. No.: US 2023/0034718 A1
(43) Pub. Date: Feb. 2, 2023

(54) CRITERIA BASED FALSE POSITIVE DETERMINATION IN AN ACTIVE LIGHT DETECTION SYSTEM

(71) Applicant: Seagate Technology LLC, Fremont, CA (US)

(72) Inventors: Mazbeen Jehanbux Palsetia, Chanhassen, MN (US); Eric James Dahlberg, Eden Prairie, MN (US)

(21) Appl. No.: 17/816,512

(22) Filed: Aug. 1, 2022

Related U.S. Application Data
(60) Provisional application No. 63/227,710, filed on Jul. 30, 2021.

(51) Int. Cl. G01S 17/08; G06N 3/08

(52) U.S. Cl. CPC G01S 17/08; G06N 3/08

(57) ABSTRACT

Method and apparatus for evaluating targets detected by an active light detection and ranging (LiDAR) system. A potential target and associated range information are obtained during an initial scan. An external sensor is initialized to sense additional information associated with the potential target. A criteria based learning circuit combines the external information from the external sensor with information from a subsequent scan to classify the potential target as a true detection condition in which a physical element is present down range from the LiDAR system, or a false positive condition where a physical element is not present down range from the LiDAR system as described by the detected range information. The external sensor may take the form of a camera. The external sensor may scan a larger surrounding area adjacent the detected potential target. Only some targets identified by the LiDAR system may be selected for evaluation using predetermined criteria.

### RELATED APPLICATION

The present application makes a claim of domestic priority to U.S. Provisional Patent Application No. 63/227,710 filed Jul. 30, 2021, the contents of which are hereby incorporated by reference.

### SUMMARY

Various embodiments of the present disclosure are generally directed to a method and apparatus for evaluating targets detected by an active light detection and ranging (LiDAR) system.

In some embodiments, a potential target and associated range information are obtained during an initial scan. An external sensor is initialized to sense additional information associated with the potential target. A criteria based learning circuit combines the external information from the external sensor with information from a subsequent scan to classify the potential target as a true detection condition in which a physical element is present down range from the LiDAR system, or a false positive condition where a physical element is not present down range from the LiDAR system as described by the detected range information. The external sensor may take the form of a camera. The external sensor may scan a larger surrounding area adjacent the detected potential target.

These and other features and advantages of various embodiments can be understood from a review of the following detailed description in conjunction with the accompanying drawings.

### BRIEF DESCRIPTION OF THE DRAWINGS

FIG. 1 is a block representation of a detection system constructed and operated in accordance with various embodiments of the present disclosure.

FIG. 2 shows a LiDAR emitter of the system in some embodiments.

FIGS. 3A through 3C show different types of output systems that can be used by various embodiments of the emitter of FIG. 2.

FIG. 4 shows a LiDAR detector of the system in some embodiments.

FIG. 5 depicts a field of view generated by the system in some embodiments.

FIG. 6 shows a criteria based learning system of the system in some embodiments.

FIG. 7 shows an aspect of the system of FIG. 1 including a LiDAR system and a camera system in accordance with some embodiments.

FIG. 8 represents a LiDAR FoV generated by the system of FIG. 7 in some embodiments.

FIG. 9 represents a camera FoV generated by the system of FIG. 7 in some embodiments.

FIG. 10A shows further aspects of the system of FIG. 7 in some embodiments.

FIGS. 10B through 10D show different responses generated by the system of FIG. 10A.

FIG. 11 is a functional block representation of the camera system in some embodiments.

FIG. 12 shows a sequence diagram for a processing operation carried out in accordance with some embodiments.

FIG. 13 shows an adaptive scan management system in accordance with further embodiments.

### DETAILED DESCRIPTION

Various embodiments of the present disclosure are generally directed to accurately evaluating and processing false positive target detection conditions in an active light detection system.

Light Detection and Ranging (LiDAR) systems are useful in a number of applications in which range information (e.g., distance, etc.) associated with a target is determined by irradiating the target with electromagnetic radiation in the form of light and then detecting timing and/or waveform characteristics of reflected light received back from the target. LiDAR systems can be used for any number of applications including topographical mapping, vehicle guidance, closed loop servo control systems, and so on.

One increasingly popular application for LiDAR is in the area of autonomously piloted or driver assisted vehicle guidance systems (e.g., self driving cars, autonomous drones, etc.). While not limiting, the light wavelengths used in a typical LiDAR system may range from ultraviolet to near infrared (e.g., 250 nanometers, nm to 1500 nm or more). Other wavelength ranges can be used. Light is a particularly useful transport mechanism to transmit and receive information.

One commonly employed form of LiDAR is sometimes referred to as coherent pulsed LiDAR, which generally uses coherent light and detects the range information based on detecting timing differences in the reflected light. Such systems may use a dual (I/Q) channel detector with an I (in-phase) channel and a Q (quadrature) channel. Other forms of LiDAR systems can be used, including non-coherent light systems, light systems that incorporate multiple detection channels, etc.

The emitted light beams can be controllably transmitted in a number of ways. Some LiDAR systems sweep the emitted light using mechanical based systems that utilize moveable mechanical elements, such as rotatable mirrored polygons or other structures (e.g., galvanometers, etc.) to mechanically direct the light beams. Other approaches use optical phase array (OPA) devices that are solid-state semiconductor base systems with no moving mechanical parts but instead use phase array mechanisms to sweep the emitted light in a direction toward the target. Still other systems use digital light processing (DLP) systems that employ an array of individually positionable micromirrors to controllably direct the light, and so on.

While operable, these and other types of LiDAR systems can have a number of limitations. One such limitation relates to the incorrect or inaccurate detection of targets in the downrange area scanned by the system, referred to sometimes as the field of view (FoV). Such errors can arise from a variety of factors, including different lighting, reflectivity characteristics of elements within the FoV, changes in atmospheric conditions, etc.

Of particular interest is a false positive condition, which occurs when the system incorrectly identifies a target that is not physically present as detected. The target may not exist at all, or a physical target may exist but the reported characteristics of the target are erroneous in a significant way. Either way, a false positive results in the reporting of a phantom/mischaracterized target and, if not corrected, the system may take action that is unwarranted and potentially hazardous (e.g., an automated braking or steering function, etc.).

Various embodiments are accordingly directed to a method and apparatus for evaluating and filtering out false positive and other related erroneous conditions within a monitored FoV. The evaluation and filtering analysis may be carried out in a variety of ways depending on the application environment, such as on a frame by frame basis using various criteria and algorithm techniques. A learning system and external sensors, such as a separate camera, can be used as part of the evaluation and filtering analysis.

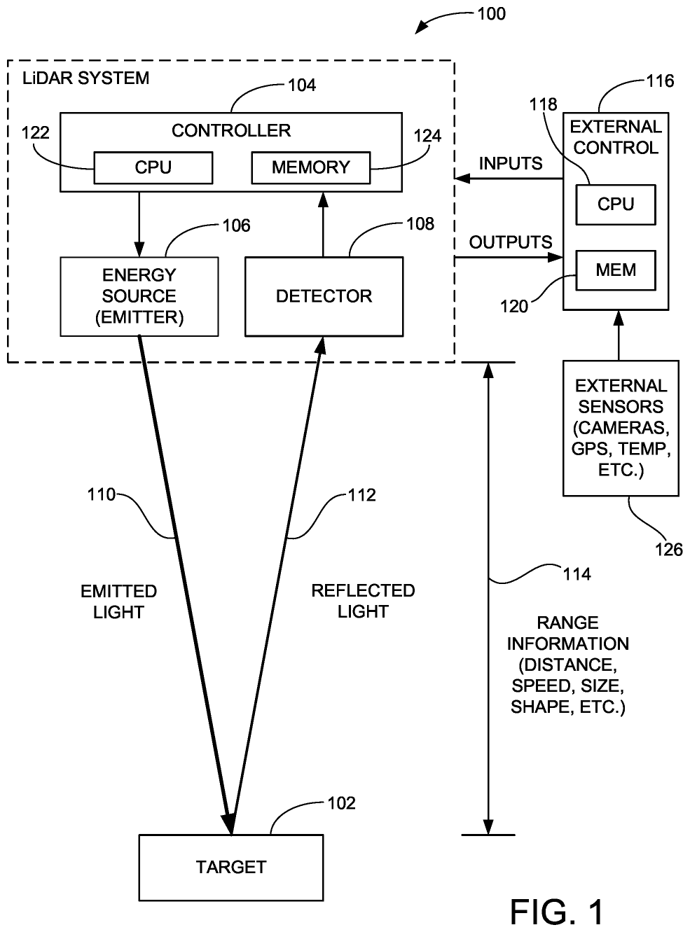

These and other features and advantages of various embodiments can be understood beginning with a review of FIG. 1, which provides a simplified functional representation of a LiDAR system 100 constructed and operated in accordance with various embodiments of the present disclosure. The LiDAR system 100 is configured to obtain range information regarding a target 102 that is a physical element located distal from the system 100. The range information can be beneficial for a number of areas and applications including but not limited to topography, archeology, geology, surveying, geography, forestry, seismology, atmospheric physics, laser guidance, automated driving and guidance systems, closed-loop control systems, etc.

The LiDAR system 100 includes a controller 104 which provides top level control of the system. The controller 104 can take any number of desired configurations, including hardware and/or software. In some cases, the controller can include the use of one or more programmable processors with associated programming (e.g., software, firmware) stored in a local memory which provides instructions that are executed by the programmable processor(s) during operation. Other forms of controllers can be used, including hardware based controllers, digital signal processors (DSPs), field programmable gate arrays (FPGAs), system on chip (SOC) integrated circuits, application specific integrated circuits (ASICs), gate logic, reduced instruction set computers (RISCs), etc.

An energy source circuit 106, also sometimes referred to as an emitter or a transmitter, operates to direct electromagnetic radiation in the form of light pulses toward the target 102. A detector circuit 108, also sometimes referred to as a receiver or a sensor, senses reflected light pulses received back from the target 102. The controller 104 directs operation of the emitted light from the emitter 106, denoted by arrow 110, and decodes information from the reflected light obtained back from the target, as denoted by arrow 112.

Arrow 114 depicts the actual, true range information associated with the intervening distance (or other range parameter) between the LiDAR system 100 and the target 102. Depending on the configuration of the system, the range information can include the relative or absolute speed, velocity, acceleration, distance, size, location, reflectivity, color, surface features and/or other characteristics of the target 102 with respect to the system 100.

The decoded range information can be used to carry out any number of useful operations, such as controlling a motion, input or response of an autonomous vehicle, generating a topographical map, recording data into a data structure for further analysis and/or operations, etc. The controller 104 perform these operations directly, or can communicate the range information to an external control system 116 for further processing and/or use.

In some cases, inputs supplied by the external control system 116 can activate and configure the system to capture particular range information, which is then returned to the system 116 by the controller 104. The external system can take any number of suitable forms, and may include a system controller (such as CPU 118), local memory 120, etc. The external system may form a portion of a closed-loop control system and the range information output by the LiDAR system 100 can be used by the external system 116 to adjust the position of a moveable element.

As noted above, the controller 104 can take a number of forms. In some embodiments, the controller 104 incorporates one or more programmable processors (CPU) 122 that execute program instructions in the form of software/firmware stored in a local memory 124, and which communicate with the external controller 118.

An additional number of systems, referred to as external sensors 126, can provide information to the external control system 116 and/or the LiDAR system 100. The external sensors can take any number of forms including but not limited to environmental sensors (e.g., temperature sensors, moisture sensors, timers, ambient light level sensors, ice detectors, etc.), cameras, geopositioning systems (e.g., global positioning systems, GPS), radar systems, proximity sensors, speedometers, etc.

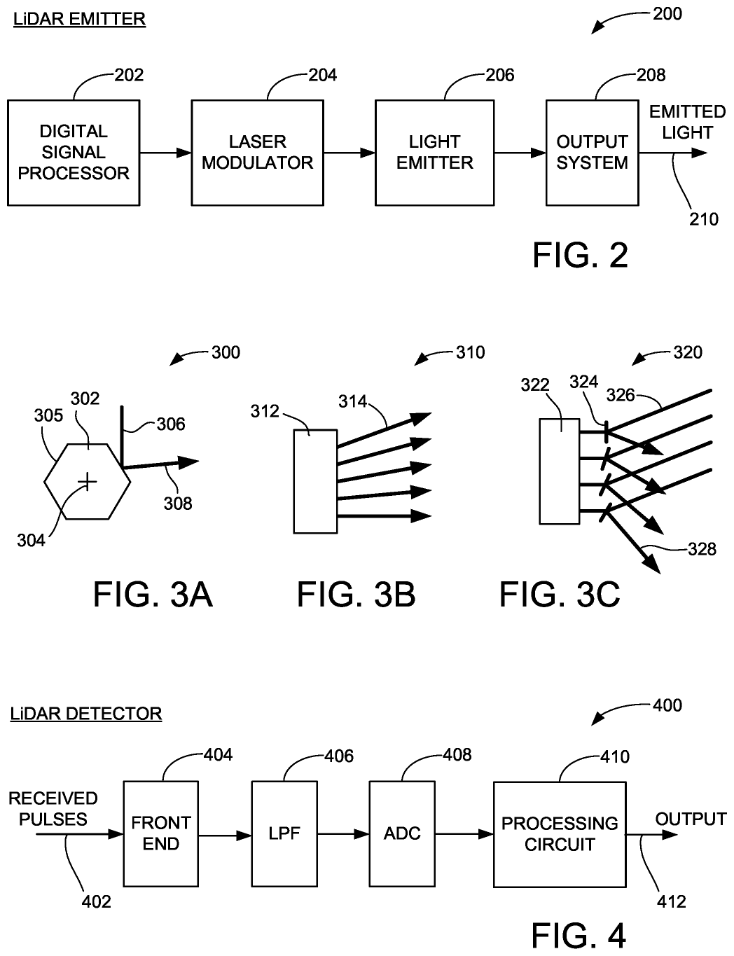

FIG. 2 depicts an emitter circuit 200 that can be incorporated into the system 100 of FIG. 1 in some embodiments. Other arrangements can be used so the configuration of FIG. 2 is merely illustrative and is not limiting. The emitter circuit 200 includes a digital signal processor (DSP) that provides adjusted inputs to a laser modulator 204, which in turn adjusts a light emitter 206 (e.g., a laser, a laser diode, etc.) that emits electromagnetic radiation (e.g. light) in a desired spectrum. The emitted light is processed by an output system 208 to issue a beam of emitted light 210. The light may be in the form of pulses, coherent light, non-coherent light, swept light, etc.

FIGS. 3A-3C show different aspects of output systems that can be used by the system of FIG. 2. Other arrangements can be used. FIG. 3A shows a system 300 that includes a rotatable polygon 302 which is mechanically rotated about a central axis 304 at a desired rotational rate. The polygon 302 has reflective outer surfaces 305 adapted to direct incident light 306 as a reflected stream 308 at a selected angle responsive to the rotational orientation of the polygon 302. The polygon is characterized as a hexagon with six reflective sides, but any number of different configurations can be used. By coordinating the impingement of light 306 and rotational angle of the polygon 302, the output light 308 can be swept across a desired field of view (FoV). Multiple polygons can be arranged along multiple orthogonal axes to provide a multidimensional scan pattern.

FIG. 3B provides a system 310 with a solid state array (integrated circuit device) 312 configured to emit light beams 314 at various selected angles across a desired FoV. Unlike the mechanical system of FIG. 3A, the solid state system of FIG. 3B has essentially no moving parts and instead scans the beam in relation to different wavelengths of the input light.

FIG. 3C shows a DLP (digital light processing) system 320 that employs a base substrate 322 that supports an array of micromirrors 324. Piezoelectric or other mechanisms can be used to deflect the micromirrors 324 and change an angle between incident light 326 and reflected light 328 to provide a desired scan pattern.

FIG. 4 provides a generalized representation of a detector circuit 400 configured to process reflected light issued by the various systems described by FIGS. 2 and 3A-3C. The detector circuit 400 receives reflected pulses 402 which are processed by a suitable front end 404. The front end 404 can include optics, detector grids, amplifiers, mixers, and other suitable features to present input pulses reflected from the target. The particular configuration of the front end 404 is not germane to the present discussion, and so further details have not been included. It will be appreciated that multiple input detection channels can be utilized.

A low pass filter (LPF) 406 and an analog to digital converter (ADC) 408 can be used as desired to provide processing of the input pulses. A processing circuit 410 provides suitable signal processing operations to generate a useful output 412.

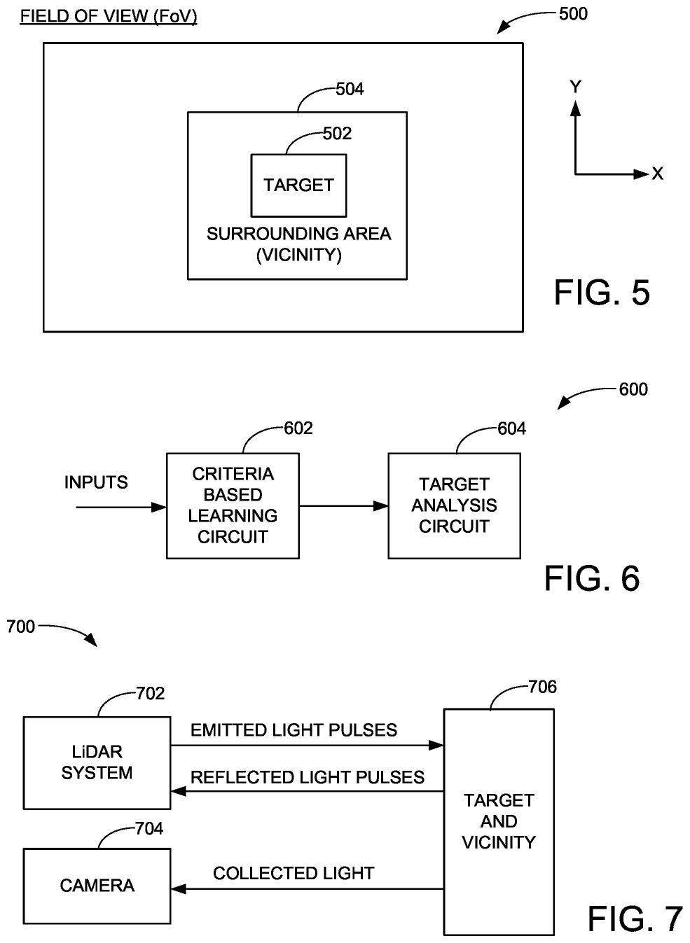

FIG. 5 shows a field of view (FoV) 500 generated by the system 100 in accordance with some embodiments. The FoV 500 generally represents that portion of the down range detection area that can be sensed and tracked by the system through the emission and receipt of emitted light beams.

The FoV 500 in FIG. 5 is generally rectangular in shape and arranged along orthogonal x-y axes. However, this is merely for purposes of illustration and is not limiting. Cartesian arrays are contemplated, but other arrangements can be used including but not limited to spherical or polar coordinates, multidimensional coordinates, single axis coordinates, etc.

In some embodiments, the light beams are emitted at a sufficient rate and density such that a three-dimensional (3D) point cloud representation of the down range environment within the FoV 500 can be generated and evaluated. While point cloud densities and frame rates can vary, some current generation system may generate several million points per second with several thousand beam points per frame and several thousand frames per second. Other resolutions and frame rates can be used.

A target is denoted at 502. Normally, the term “target” is often broadly used to describe both a physical element down range from the LiDAR system as well as the response obtained within the FoV in detecting the element. However, the present disclosure is directed to differentiating between false positive conditions and true detection conditions. Hence, the term “target” will hereinafter be limited to the response obtained by the detector, and the term “element” or “physical element” will refer to the actual, physically manifested object that, under true detection conditions, will correspond to the detected target within the detection capabilities of the system.

In a true detection condition, the target and the physical element will coincide and so in these situations the terms will be used interchangeably. In a false positive condition, a target will be detected, but there may not be a physical element present at all, or a physical element may be present but the detected target may have erroneous range information that is significantly different from that of the physical element. Thus, in a false positive condition there will be significant divergence between the target and the physical element and so these elements cannot be viewed as the same.

The detected range information can include distance to the target, relative speed of the target, type, size and/or shape of the target, surface characteristics of the target, projected future trajectory of the target, etc. These and other types of range information are nominally derived from the reflected light pulses obtained back from the physical element. Complex signal processing techniques can be employed to derive the desired range information associated with the target, including using information from a single frame or pulses integrated over multiple successive frames.

Of particular interest to the present discussion is whether the detection and evaluation of the target 502 within the FoV 500 is an accurate determination of a corresponding physical element that gave rise to the detected target. To this end, various embodiments of the present disclosure provide a number of mechanisms and approaches that can be used to reduce the occurrence of false positives and other related erroneous conditions. As explained below, at least some embodiments operate to evaluate an additional portion 504 of the FoV 500 adjacent the target 502, referred to herein as the surrounding area or vicinity, to validate the acquired target information.

The relative size, shape, aspect ratio, and other defining characteristics of the vicinity 504 as shown in FIG. 5 are merely representative and are not limiting. Rather, the vicinity 504 can be understood as an area external to the detection area of the target that is adjacent to and or otherwise has some meaningful relationship to the area of the target.

It is not necessarily required that the vicinity 504 fully surround the target 502 as in FIG. 5. Depending on the application, examining portions that are adjacent a single side of the target, less than all of a single side of the target, less than all of the sides of the target, non-contiguous with the target, etc., can be sufficient for evaluation and therefore are contemplated as falling within the vicinity of the target. In one example, if the target is detected as moving along a particular vector, then areas where the target may be expected to appear in the near future, assuming the purported target continues to follow the estimated vector trajectory, can be viewed as the vicinity even if these are in different locations within the overall FoV 500.

FIG. 6 provides a processing system 600 that can be operated to provide target differentiation and verification aspects of the present disclosure in accordance with some embodiments. Other arrangements can be used. The system 600 includes a criteria based learning system 602 and a target analysis circuit 604. The learning system 602 can take any number of suitable forms including an artificial neural net or other machine learning system.

In some cases, each LiDAR system is separately adaptable and is calibrated during a learning mode that can be carried out during manufacturing and/or field use. In other cases, a base system can be empirically provided with some preestablished learning capabilities, after which further learning is provided individually by the system during use.

Once the learning system 602 is functional, various inputs are supplied and these are used to provide an output to the target analysis circuit 604, which in turn makes a decision regarding the validity and accuracy of the target information from the FoV.

As with many learning systems such as in FIG. 6, a wide variety of inputs are available and can be supplied to the system. It is contemplated that at least some of these inputs will be supplied by one or more external sensors (see e.g., FIG. 1) that provide further information to the system.

FIG. 7 shows one embodiment 700 in which a LiDAR system 702 such as depicted above is used in conjunction with a separate sensor in the form of a camera 704 to provide information associated with a target and the surrounding vicinity 706. The LiDAR system 702 is an active light system that operates by emitting light pulses and receiving light pulses. The camera 704 is a passive light system that operates by processing collected light received from the surrounding environment.

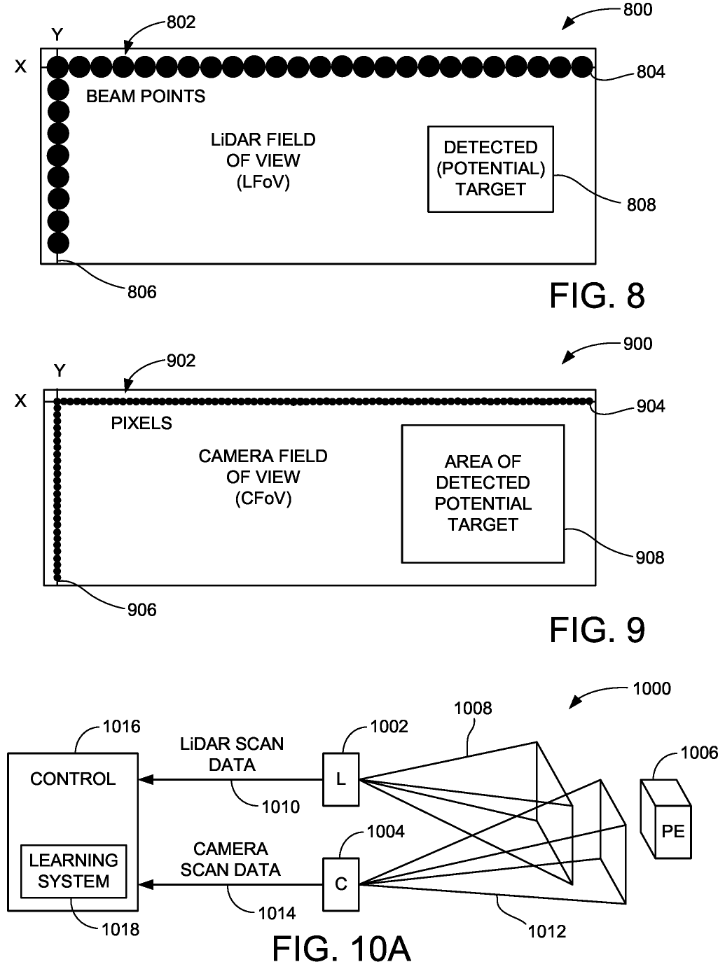

FIG. 8 provides a schematic representation of an FoV 800 obtained by the system of FIG. 7 in some embodiments. The FoV 800 is generated by the LiDAR system 702 and is referred to as a LiDAR field of view (LFoV) or a baseline FoV.

The LFoV 800 is scanned using beam points 802 that are rasterized along multiple orthogonal x-y directions denoted by rows and columns 804, 806. Any number of suitable rasterizing patterns can be used, including patterns along a single direction, patterns with different beam point densities in different regions, patterns that provide different wavelengths or other waveform characteristics to the emitted beam pulses, etc. The actual sizes, spacings, densities and refresh rates (frame rates) of the beam points 802 in the FoV 800 will depend upon the configuration of the system, so that the pattern, frame rate and resolution shown in FIG. 8 are merely illustrative and is not limiting.

A detected target within the LFoV 800 is represented at 808. The target is identified as a potential target on the basis that a response was generated by the system, but verification is desirable to determine that the target detection does not involve a false positive condition.

Accordingly, FIG. 9 shows a second FoV 900 further generated by the system of FIG. 7 in some embodiments. The FoV 900 is referred to as a camera field of view (CFoV) and is generated by the camera 704.

As before, the CFoV 900 is made up of points (in this case, pixels) 902 arranged as before along orthogonal x-y axes provided by rows and columns 904, 906. The camera resolution will be established by the resolution of the camera. As before, the number of pixels may be in the tens or hundreds of millions of pixels per second. It is contemplated that a camera will tend to provide a greater resolution than a LiDAR system as depicted in FIGS. 8-9, but this is merely exemplary and is not limiting.

Depending on the configuration of the camera system (which can also be characterized as a video system), the number of frames per second may be in the tens or hundreds per second while the number of pixels per second may be in the hundreds of thousands or millions per frame. As before, the size, shape, spacing, pattern, frame rate and resolution in FIG. 9 are merely exemplary and other configurations can be used. While the respective FoVs in FIGS. 8 and 9 are shown to be nominally the same size, in practice these may be different, so that one may overlap the other by a significant extent, have different focal depths, aspect ratios, angles of view, etc.

At this point it will be helpful to briefly discuss the differences between the different FoVs views 800, 900 represented in FIGS. 8-9. The CFoV 900 from FIG. 9 from the camera will largely be based on passive, collected ambient light in the visible spectrum, whereas the LFoV 800 is based on an active light system operative in (most likely an infrared or ultraviolet) non-visible spectrum. These different spectra can provide useful information to the system in filtering out false positives.

Another difference is the density; each frame of the camera will tend to provide significantly greater resolution as compared to each frame of the LiDAR system, at least within certain ranges. By contrast, the LiDAR system will tend to provide a significantly higher frame rate, providing a lower bit density resolution but at a faster rate (more frames per second).

Yet another difference is that the camera can normally only supply a two-dimensional (2D) representation of the surrounding environment, as there will be no depth/range (e.g., z direction) information available from the data other than perspective or shielding effects provided by objects being closer or farther away in the field of view. This is in contrast to the 3D point cloud representation provided by the LiDAR system which at least normally provides a highly accurate distance range measurement for every point within the associated FoV. This is because each beam point in FIG. 8 will nominally have a z-axis (range) value associated with the timing characteristics of the returned pulses. This also means that beam point widths may vary slightly based on distance to the target.

Finally, while not necessarily required, both the LiDAR system (FIG. 8) and the camera system (900) 700 and camera system may have steering capabilities built into these systems, so that beams/focus can be steered to a particular area. Such steering operations can be carried out electronically and/or mechanically. Stated another way, once a target is identified in the field of view requiring verification, the LiDAR system can enhance localized scanning in this region, and the camera can additionally or alternatively be activated to focus in on or otherwise provide information directed to the target area.

Continuing with FIG. 9, an area 908 is identified that corresponds to the potential target area 808 from FIG. 8. The area 908 is somewhat larger than the target area 808 since the area 908 includes both the target area and some portion of the surrounding area (vicinity). It is contemplated in some embodiments that, upon detection of the potential target 808 in FIG. 8, the system will direct the camera to obtain data associated with the area 908 in FIG. 9 as part of the evaluation analysis.

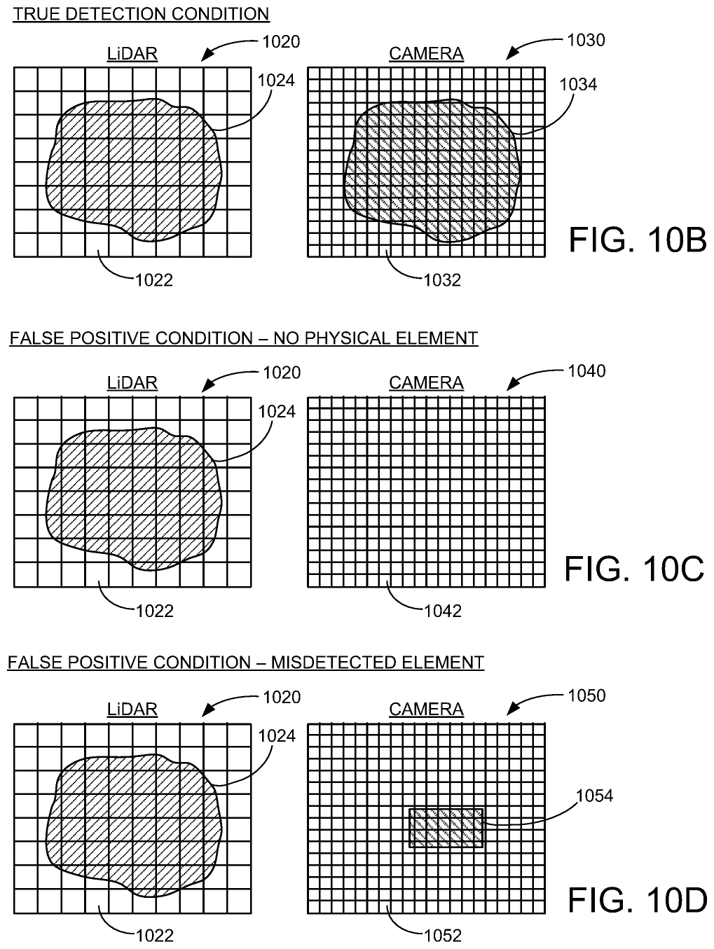

FIG. 10A shows another representation of an analysis system 1000 similar to the system 700 discussed above and capable of generating FoVs such as represented in FIGS. 8-9. The system 1000 includes a LiDAR system (L) 1002, a camera system (C) 1004, and physical element (PE) 1006.

The LiDAR system 1002 scans the selected LFoV and (normally) detects the PE 1006 as an associated target, as indicated by scan beam profile 1008. In response, the LiDAR system 1002 outputs corresponding sensed data 1010 at a first frame rate and a first resolution for each of the emitted scan beam profiles 1008.

The camera system 1004 concurrently scans the associated CFoV and (normally) detects the PE 1006 using collected light beam 1012. The camera 1004 also outputs corresponding sensed data 1014 at a second frame rate and a second resolution for each image captured at 1012.

The output sensed data from the respective LiDAR and camera systems 1002, 1004 are processed by a control circuit 1016. The circuit 1016 includes a learning system 1018 that facilitates processing of the scan data 1010, 1014 in order to arrive at a judgment as to the validity of the characterized physical element 1006.

The evaluation by the circuit 1016 can be carried out in a number of ways. For example, a detected target by the successive frames of LiDAR scans 1008 will tend to persistently occur and will have a detectable boundary that can be characterized within the resolution of the system. This boundary can be compared to similar boundary characteristics obtained from the camera response. Boundaries in both the LiDAR and camera system can also be tracked frame-to-frame. Light densities, contrast levels, amplitude levels and other parameters in the respective received responses can also be incorporated into the analysis. Training data both during a calibration routine and subsequent use can further be used to train the system.

FIGS. 10B through 10D have been provided to illustrate different responses that may be respectively obtained by the system 1000 in FIG. 10A under different operational conditions. FIG. 10B shows a true detection condition where a LiDAR response 1020 accurately detects the physical element 1006 within acceptable limits of the system. The response 1020 is made up of beam points 1022 arrayed as shown corresponding to different pulses directed to the rasterized area of the LPoV.

A target response from the physical element 1006 is generally indicated at 1024; in practice, the response may be more block-like than that shown; those points 1022 in which only a portion of the target 1024 occurs may be characterized as portions having a reduced amplitude response, thereby enabling the system to generally calculate the boundary contours of the detected target.

A camera response is depicted at 1030, with corresponding pixels 1032 and detected target 1034. In this case, the image quality, boundary calculation and resolution will be different from the LiDAR response 1020, but overall, the system will determine sufficient correspondence between the detected target 1024 and detected target 1034 to verify the range information. Stated another way, the boundary contour at 1034 and the boundary contour at 1024 can be compared as part of the verification operation to verify the range information obtained from the LiDAR system 1002 (FIG. 10A) is valid.

FIG. 10C shows another detection situation where the LiDAR response 1020 detects the target 1024 as before, but in this case a corresponding camera response 1040 made up of pixels 1042 does not differentiate a corresponding target within the camera response area.

In this case, FIG. 10C can represent a false positive condition where no physical element is present at all, as determined (at least in part) by the response from the camera 1040. The LiDAR response that shows a target may be due to other factors (noise, cross-talk, bloom event, etc.), and the lack of an image in the camera response 1040 confirms this.

However, the lack of a corresponding image of an underlying physical element by the camera is not necessarily dispositive; it may still be possible that the physical element is present, but environmental conditions (e.g., fog, glare, moisture on a lens cover, lighting conditions, etc.) prevent the camera response from providing a differentiation sufficient to confirm the presence of the physical element. The camera is a highly useful external sensor, but is not the only sensor that may be used and is not necessarily required to make the false positive condition determination. The learning system can use other inputs to ultimately determine whether a response as depicted in FIG. 10C is actually a false positive condition, or a physical element is still present. It will be noted that the system response (e.g., driver notifications, etc.) may be different based on the detected responses of FIG. 10B as compared to FIG. 10C.

FIG. 10D shows yet another condition with the same LiDAR response 1020 and detected target 1024 being received as before, but a different camera response 1050 is provided (using pixels 1052 and target area 1054). In this case, the camera response 1050 indicates a potential target in the area 1054, but it has different characteristics (e.g., size, shape, etc.) as compared to what would be expected from the response 1024. This raises the possibility that a bloom response or other effect has been detected, such as from a retroreflector or other highly reflective element that provides the LiDAR response 1024 with a significantly greater output as compared to the camera response 1050. In this latter case, should the camera provide a response that a target device may in fact be physically present, the learning system can utilize this information as a yet third example case and process the results accordingly.

The simplified examples of FIGS. 10A through 10D show a few of many different possible use cases where target verification can be carried out using external sensors. Additional criterion can be incorporated including GPS, previous history data, environmental sensors, etc. to enable the system to correctly determine whether the detected target by the LiDAR system corresponds to an actual physical element in the field of view.

A step-wise analysis sequence may be taken such that, once a potential target is identified by the LiDAR system, the system analyzes other responses such as the camera response; but whether the camera response shows the target (FIG. 10B), no target (FIG. 10C) or a different target (FIG. 10D) will be further inputs used by the system in making the final true/false target detection decision. Feedback will be used to help the system adaptively adjust to more accurately make future detection decisions.

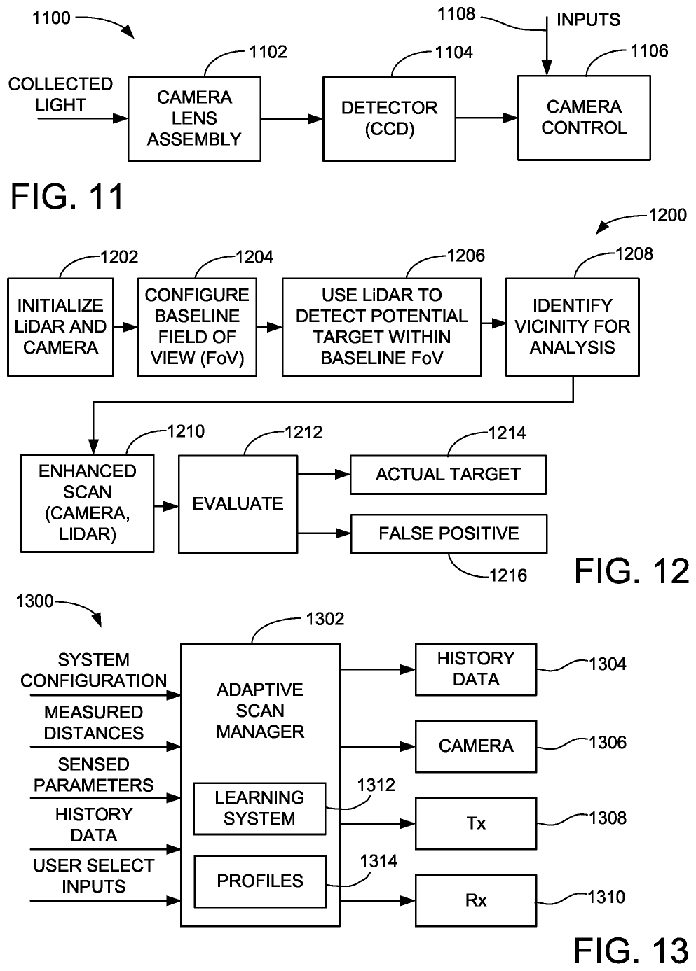

FIG. 11 provides a functional block representation of a camera 1100 that can correspond to the various camera systems discussed above. Other configurations can be used. The camera 1100 includes a camera lens assembly 1102, which can be one or more optical lens assemblies to focus and collect light from the surrounding environment.

A detector (CCD or charge coupled device) 1104 is configured to receive the collected light from the assembly 1102 and direct that to a camera control unit 1106, which in turn processes the detected light in accordance with the foregoing discussion responsive to inputs 1108 supplied by the system.

FIG. 12 provides a sequence flow 1200 to illustrate steps carried out in accordance with some embodiments. Other steps can be taken as required.

A system such as described above is initialized at block 1202. The system includes a LiDAR system and one or more external sensors such as a camera, such as provided above. A baseline FoV is selected and configured at block 1204. This enables the system to initiate operate at 1206 to utilize the LiDAR to illuminate and detect various targets within the baseline FoV.

In some cases, the system will continue operation in accordance with block 1206 to identify various targets and take associated actions in response. Hence, it is contemplated that the processing of targets to determine whether a false positive condition has arisen may occur on a selective basis, such as when targets are located that meet certain criteria (e.g., a particular size, shape, location, velocity, etc.). In these embodiments, most detected targets are processed normally, but under certain circumstances additional processing is applied to selected targets to further verify the information associated with the selected targets. The criteria used to select a particular target from a number of different targets within the FoV may be obtained from comparison of the range information to a predetermined threshold value.

When a selected target is identified as warranting evaluation, the process continues to block 1208 where a corresponding vicinity area is identified that is adjacent the selected target. As noted above, this can include an area that fully or partially surrounds the target, or is otherwise a location that is adjacent the selected target.

An enhanced scan mode is next performed at block 1210. The enhanced scan mode includes additional scanning of the vicinity area identified in block 1208. This can include a higher resolution scan by the LiDAR scan, additional scans by another sensor such as the camera, as well as the acquisition of other information such as environmental information, etc. from other sensors. These and other inputs are supplied to the evaluation system for evaluation at block 1212 in an effort to determine whether the detected target is accurately detected, as indicated at block 1214, or a false positive detection condition exists, as indicated at block 1216. Further processing is carried out accordingly.

FIG. 13 provides a functional block representation of an adaptive scan management system 1300 constructed and operated in accordance with further embodiments. The system 1300 includes an adaptive scan manager circuit 1302 which operates as described above to carry out false positive evaluation processing on selected targets detected by the system. The manager circuit 1302 can be realized as hardware, firmware and/or software. In some embodiments, the circuit 1302 is incorporated into the controller 104 as a firmware routine stored in the local memory 124 and executed by the controller processor 122.

The manager circuit 1302 uses a number of inputs including system configuration information, measured distance for various targets, various other sensed parameters from the system (including external sensors 126), history data accumulated during prior operation, and user selectable inputs. Other inputs can be used as desired.

The manager circuit 1302 uses these and other inputs to provide various outputs including accumulated history data 1304 indicative of prior detection operations, which is stored in a local memory such as 124 for future reference. The manager 1302 further operates to provide various control signals to other aspects of the system, including a camera 1306, an emitter (transmitter Tx) 1308 and a detector (receiver Rx) 1310 to implement evaluation operations as described above including in FIG. 12. An adaptive learning system 1312 and various stored profiles 1314 can be used as described above to assist in the false positive evaluation operations.

It can now be understood that various embodiments provide a LiDAR system with the adaptive capability of evaluating targets to detect and filter out false positive conditions, thereby enabling the system to more accurately assess and respond to the surrounding environment. Various criteria including information from one or more external sensors, such as a camera, can be used as part of the evaluation processing. Any number of alternatives will readily occur to the skilled artisan in view of the foregoing discussion.

While coherent, I/Q based systems have been contemplated as a basic environment in which various embodiments can be practiced, such are not necessarily required. Similarly, while solid-state OPA outputs are particularly suitable for various embodiments, in alternative configurations other types of output systems can be employed, including mechanical systems such as galvanometers or rotatable polygons, micromirror technology, etc.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. An apparatus comprising:
a light detection and ranging (LiDAR) system comprising an emitter configured to perform an initial scan of light beams across a field of view (FoV) and a detector configured to generate range information associated with a potential target down range from the LiDAR system responsive to the initial scan;
an external sensor configured to sense external information associated with the potential target within the FoV; and
a criteria based learning circuit configured to identify a false positive condition associated with the range information from the potential target by combining the external information from the external sensor with detection information obtained from the detector during a subsequent scan by the emitter.

2. The apparatus of claim 1, wherein the external sensor comprises a camera which operates to collect ambient light from the FoV from a vicinity adjacent the potential target.

3. The apparatus of claim 1, wherein the criteria based learning circuit activates the external sensor responsive to the detection of the potential target by the detector, and uses the external information from the external sensor and the detection information from the subsequent scan from the emitter to differentiate between the false positive condition and a true detection condition in which the range information is nominally correct, and outputs a corrective action signal to an external control system responsive to whether the false positive condition or the true detection condition is determined.

4. The apparatus of claim 3, wherein the external sensor is activated by the criteria based learning circuit responsive to a comparison of the range information to a predetermined threshold.

5. The apparatus of claim 1, wherein the LiDAR system actively emits and detects light beams over a first range of wavelengths and the external sensor passively receives light beams over a different, second range of wavelengths.

6. The apparatus of claim 1, wherein the criteria based learning system uses an artificial neural network to determine the presence or absence of a physical element corresponding to the detected potential target.

7. The apparatus of claim 1, wherein the criteria based learning circuit is further configured to determine that a physical element is present downrange from the LiDAR system corresponding to the potential target, but further determines that at least one aspect of the corresponding range information detected from the detector is erroneous using the external sensor.

8. The apparatus of claim 1, wherein the criteria based learning circuit increases a density of beam points in a vicinity of the potential target during the subsequent scan.

9. The apparatus of claim 1, wherein the detected potential target has a first overall boundary area within the FoV from the detector, and the criteria based learning circuit directs the external sensor to scan an area within the FoV that includes the first overall boundary area as well as a second surrounding area adjacent the first overall boundary area.

10. The apparatus of claim 1, wherein the subsequent scan is provided with a first resolution and frame rate, and the external information from the external sensor is provided with a higher, second resolution and a second, lower frame rate.

11. The apparatus of claim 1, wherein the criteria based learning circuit declares a true condition exists based on detection, by the external sensor, of a physical element corresponding to the target detected by the LiDAR system.

12. The apparatus of claim 1, wherein the criteria based learning circuit declares a false positive condition exists based on a lack of detection, by the external sensor, of a physical element corresponding to the target detected by the LiDAR system.

13. The apparatus of claim 1, wherein the criteria based learning circuit declares a bloom event exists responsive to detection, by the external sensor, of a physical element down range of the LiDAR system in the vicinity of the potential target detected by the LiDAR system, the physical element detected by the external sensor having a first overall size smaller than a second overall size of the potential target detected by the LiDAR system.

14. The apparatus of claim 1, wherein the criteria based learning circuit is realized as at least one programmable processor which executes corresponding program instructions stored in an associated memory.

15. A method comprising:
using a light detection and ranging (LiDAR) system to detect range information associated with a potential target down range from the LiDAR system within an associated field of view (FoV) during an initial scan by the LiDAR system;
initializing an external sensor to sense external information associated with the potential target; and
utilizing a criteria based learning circuit to combine the external information from the external sensor with information from a subsequent scan by the LiDAR system to classify the potential target as corresponding to a true detection condition in which a physical element is present down range from the LiDAR system as described by the detected range information, or as corresponding to a false positive condition where a physical element is not present down range from the LiDAR system as described by the detected range information; and
outputting a detection signal to an external control system responsive to the classification of the potential target as corresponding to the true detection condition or the false positive condition.

16. The method of claim 15, wherein the external sensor is characterized as a camera which passively collects light from the FoV to generate the external information.

17. The method of claim 15, further comprising activating the external sensor to scan a vicinity of the potential target responsive to the range information associated with the potential target meeting or exceeding a predetermined threshold.

18. The method of claim 15, further comprising using an artificial neural network circuit to differentiate between the true detection condition and the false positive condition regarding the potential target.

19. The method of claim 15, wherein a first scan profile having a first beam point density is used during the initial scan and a different, second scan profile having a higher second beam point density is used during the subsequent scan.

20. The method of claim 15, wherein the potential target is located within a first overall boundary area within the FoV of the LiDAR system, and wherein the criteria based learning circuit directs the external sensor to scan an area within the FoV that includes the first overall boundary area as well as a second surrounding area adjacent the first overall boundary area.
